(19) United States
(12) Patent Application Publication
(10) Pub. No.: US 2007/0003105 A1
(43) Pub. Date: Jan. 4, 2007

(54) Monitoring system, monitoring method, and monitoring program

(75) Inventors: Satoshi Nakamura, Saitama (JP); Masahiko Sugimoto, Saitama (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/476,073

(22) Filed: Jun. 28, 2006

(30) Foreign Application Priority Data
Jun. 29, 2005 (JP) 2005-190551

(51) Int. Cl. G06K 9/00

(52) U.S. Cl. 382/103

(57) ABSTRACT

An object of the present invention is to reduce a data amount of a frame image to reduce a data amount of a captured image. A monitoring system according to the present invention includes: an image capturing section that takes a moving image including a plurality of frame images; a figure authenticating section that authenticates whether a figure included in each of a plurality of frame images taken by the image capturing section is a figure previously registered; a data amount changing section that reduces, when a figure included in a frame image taken by the image capturing section has been authenticated by the figure authenticating section, a data amount of that frame image; and an image storing section that displaces, among the plurality of frame images taken by the image capturing section, a frame image in which a figure has been authenticated by the figure authenticating section by a frame image of which a data amount has been reduced by the data amount changing section to store the displaced frame image.

### CROSS REFERENCE TO THE RELATED APPLICATION

This patent application claims priority from a Japanese Patent Application No. JP 2005-190551 filed on Jun. 29, 2005, the contents of which are incorporated herein by reference.

### BACKGROUND OF THE INVENTION

1. Field of the Invention

The present invention relates to a monitoring system, a monitoring method, and a monitoring program. More particularly, the present invention relates to a monitoring system, a monitoring method, and a monitoring program for effectively reducing a data amount of a captured image.

2. Description of Related Art

In recent years, a monitor making use of an image capturing apparatus has been arranged at various places to be used for the detection of an invader. Then, the monitor previously takes a reference image for an image capturing area and compares the reference image and a captured image in order to detect the change of a subject. When the change of a subject is detected by comparing the reference image and the captured image, an apparatus for reducing a compression rate of the captured image according to the fact that the movement of subject has been changed in the image capturing area of the image capturing apparatus is proposed as disclosed, for example, in Japanese Patent Application Publication No. 2002-335492.

It is necessary that a monitor acquires an image covering a wide area with the aim of monitoring the behavior of a figure detected within an image capturing area. Furthermore, it is also necessary that a monitor acquires an image with enough picture quality to specify a figure detected within an image capturing area. Here, when continuing to take a moving image with high picture quality enough to specify a figure in order to specify the figure detected within an image capturing area, a capacity of a storage device to store the moving image may be insufficient. On the other hand, when taking a moving image with low picture quality with the aim of reducing communications traffic with which an image capturing apparatus communicates with an outside via Internet or the like and a capacity of a storage device to store the moving image, a figure detected within an image capturing area may not be specified.

According to the invention as described Japanese Patent Application Publication No. 2002-335492, when the movement of a subject is changed in an image capturing area, a compression rate of images to be taken is set low even though what kind of figure is the subject. Then, while the subject includes a movement, the image capturing apparatus continues to take a moving image as the compression rate of images to be taken is set low. However, in the invention as described Japanese Patent Application Publication No. 2002-335492, since an image capturing apparatus takes a moving image with a low compression rate irrespective of the type of subject and further takes a moving image as the compression rate of images to be taken is set low while the subject includes a movement after authenticating a figure of the subject, there is a problem that communications traffic is not reduced when the captured images are sent to an outside by means of communication. Furthermore, since images are stored or sent as a compression rate is set low, it may be difficult to effectively reducing a data amount of a captured image.

### SUMMARY OF THE INVENTION

Therefore, it is an object of the present invention to provide a monitoring system, a monitoring method, and a monitoring program that can solve the foregoing problems. The above and other objects can be achieved by combinations described in the independent claims. The dependent claims define further advantageous and exemplary combinations of the present invention.

According to the first aspect of the present invention, there is provided a monitoring system. The monitoring system includes: an image capturing section that takes a moving image including a plurality of frame images; a figure authenticating section that authenticates whether a figure included in each of a plurality of frame images taken by the image capturing section is a figure previously registered; a data amount changing section that reduces, when a figure included in a frame image taken by the image capturing section has been authenticated by the figure authenticating section, a data amount of that frame image; and an image storing section that displaces, among the plurality of frame images taken by the image capturing section, a frame image in which a figure has been authenticated by the figure authenticating section by a frame image of which a data amount has been reduced by the data amount changing section to store the displaced frame image. Moreover, the monitoring system may further include a presence-of-figure judging section that judges whether a figure is included in each of the plurality of frame images taken by the image capturing section, the data amount changing section may reduce a data amount of a frame image in which the presence-of-figure judging section has judged that a figure is not included, and the image storing section may displace, among the plurality of frame images taken by the image capturing section, a frame image in which the presence-of-figure judging section has judged that a figure is not included by the frame image taken by the image capturing section to store the frame image of which a data amount has been reduced by the data amount changing section. Further, the data amount changing section may displace an image area of a figure included in the frame image taken by the image capturing section by a predetermined template image in order to reduce a data amount of the frame image taken by the image capturing section.

According to the second aspect of the present invention, there is provided a monitoring method. The monitoring method includes: a figure authenticating step of authenticating whether a figure included in each of a plurality of frame images taken by an image capturing section for taking a moving image is a figure previously registered; a data amount changing step of reducing, when a figure included in a frame image taken by the image capturing section has been authenticated in the figure authenticating step, a data amount of that frame image; and an image storing step of displacing, among the plurality of frame images taken by the image capturing section, a frame image in which a figure has been authenticated in the figure authenticating step by a frame image of which a data amount has been reduced in the data amount changing step to store the displaced frame image.

According to the third aspect of the present invention, there is provided a monitoring program for a monitoring system. The monitoring program makes the monitoring system function as: an image capturing section that takes a moving image including a plurality of frame images; a figure authenticating section that authenticates whether a figure included in each of a plurality of frame images taken by the image capturing section is a figure previously registered; a data amount changing section that reduces, when a figure included in a frame image taken by the image capturing section has been authenticated by the figure authenticating section, a data amount of that frame image; and an image storing section that displaces, among the plurality of frame images taken by the image capturing section, a frame image in which a figure has been authenticated by the figure authenticating section by a frame image of which a data amount has been reduced by the data amount changing section to store the displaced frame image.

According to the fourth aspect of the present invention, there is provided a monitoring system. The monitoring system includes: an image capturing section that takes a moving image including a plurality of frame images; a propriety-of-authentication judging section that judges whether a figure included in each of the frame images taken by the image capturing section is a frame image enough to be authenticated by a figure authenticating apparatus; a data amount changing section that reduces, when the propriety-of-authentication judging section judges that a figure included in a frame image taken by the image capturing section is an image enough to be authenticated by the figure authenticating apparatus, a data amount of frame images that are continuously taken next to that frame image and include a figure identical with the figure included in that frame image; and an image storing section that displaces, among the plurality of frame images taken by the image capturing section, frame images that are continuously taken next to a frame image, in which the propriety-of-authentication judging section judges that the frame image is an image enough to be authenticated by the figure authenticating apparatus, and include a figure identical with the figure included in that frame image by a frame image of which a data amount has been reduced by the data amount changing section to store the displaced frame images. Moreover, the propriety-of-authentication judging section may judge whether resolution of a face portion of the figure included in the frame image taken by the image capturing section is resolution by which the figure authenticating apparatus can authenticate a figure. Furthermore, the propriety-of-authentication judging section may judge whether the direction of a face of the figure included in the frame image taken by the image capturing section is the direction of a face by which the figure authenticating apparatus can authenticate a figure.

According to the fifth aspect of the present invention, there is provided a monitoring method. The monitoring method includes: a propriety-of-authentication judging step of judging whether a figure included in each of frame images taken by an image capturing section for taking a moving image is a frame image enough to be authenticated by a figure authenticating apparatus; a data amount changing step of reducing, when the propriety-of-authentication judging step judges that a figure included in a frame image taken by the image capturing section is an image enough to be authenticated by the figure authenticating apparatus, a data amount of frame images that are continuously taken next to that frame image and include a figure identical with the figure included in that frame image; and an image storing step of displacing, among the plurality of frame images taken by the image capturing section, frame images that are continuously taken next to a frame image, in which the propriety-of-authentication judging step judges that the frame image is an image enough to be authenticated by the figure authenticating apparatus, and include a figure identical with the figure included in that frame image by a frame image of which a data amount has been reduced in the data amount changing step to store the displaced frame images.

According to the sixth aspect of the present invention, there is provided a monitoring program for a monitoring system. The monitoring program makes the monitoring system function as: an image capturing section that takes a moving image including a plurality of frame images; a propriety-of-authentication judging section that judges a figure included in each of the frame images taken by the image capturing section is a frame image enough to be authenticated by a figure authenticating apparatus; a data amount changing section that reduces, when the propriety-of-authentication judging section judges that a figure included in a frame image taken by the image capturing section is an image enough to be authenticated by the figure authenticating apparatus, a data amount of frame images that are continuously taken next to that frame image and include a figure identical with the figure included in that frame image; and an image storing section that displaces, among the plurality of frame images taken by the image capturing section, frame images that are continuously taken next to a frame image, in which the propriety-of-authentication judging section judges that the frame image is an image enough to be authenticated by the figure authenticating apparatus, and include a figure identical with the figure included in that frame image by a frame image of which a data amount has been reduced by the data amount changing section to store the displaced frame images.

According to the seventh aspect of the present invention, there is provided a monitoring system. The monitoring system includes: an image capturing section that takes a moving image including a plurality of frame images; a direction-of-figure computing section that computes a direction for the image capturing section of a face of a figure included in each of frame images taken by the image capturing section; a direction-of-figure judging section that judges whether an angle formed by the direction of the face of the figure computed from the direction-of-figure computing section and a direction from the image capturing section to that figure is smaller than a predetermined angle; a data amount changing section that reduces a data amount of that frame image when the direction-of-figure judging section judges that an angle formed by the direction of the face of the figure computed from the direction-of-figure computing section and the direction from the image capturing section to that figure is smaller than the predetermined angle; and an image storing section that displaces, among the plurality of frame images taken by the image capturing section, a frame image, in which the direction-of-figure judging section judges that the direction of the face of the figure in the frame image computed from the direction-of-figure computing section is not within a predetermined range with respect to the image capturing section, by a frame image of which a data amount is reduced by the data amount changing section to store the displaced frame image. Moreover, the direction-of-figure computing section may include: a face area specifying section that specifies an area of a face of a figure included in the frame image taken by the image capturing section; a part position specifying section that specifies a position of a part of the face for the area of the face of the figure specified by the face area specifying section; and a direction-of-face computing section that computes a direction for the image capturing section of the face of the figure included in the frame image taken by the image capturing section based on the position of the part of the face for the area of the face of the figure specified by the part position specifying section.

According to the eighth aspect of the present invention, there is provided a monitoring method. The monitoring method includes: a direction-of-figure computing step of computing a direction for an image capturing section of a face of a figure included in each of frame images taken by the image capturing section for taking a moving image; a direction-of-figure judging step of judging whether an angle formed by the direction of the face of the figure computed in the direction-of-figure computing step and a direction from the image capturing section to that figure is smaller than a predetermined angle; a data amount changing step of reducing a data amount of that frame image when the direction-of-figure judging step judges that an angle formed by the direction of the face of the figure computed in the direction-of-figure computing step and the direction from the image capturing section to that figure is smaller than the predetermined angle; and an image storing step of displacing, among the plurality of frame images taken by the image capturing section, a frame image, in which the direction-of-figure judging step judges that the direction of the face of the figure in the frame image computed in the direction-of-figure computing step is not within a predetermined range with respect to the image capturing section, by a frame image of which a data amount is reduced in the data amount changing step to store the displaced frame image.

According to the ninth aspect of the present invention, there is provided a monitoring program for a monitoring system. The monitoring program makes the monitoring system function as: an image capturing section that takes a moving image including a plurality of frame images; a direction-of-figure computing section that computes a direction for the image capturing section of a face of a figure included in each of frame images taken by the image capturing section; a direction-of-figure judging section that judges whether an angle formed by the direction of the face of the figure computed from the direction-of-figure computing section and a direction from the image capturing section to that figure is smaller than a predetermined angle; a data amount changing section that reduces a data amount of that frame image when the direction-of-figure judging section judges that an angle formed by the direction of the face of the figure computed from the direction-of-figure computing section and the direction from the image capturing section to that figure is smaller than the predetermined angle; and an image storing section that displaces, among the plurality of frame images taken by the image capturing section, a frame image, in which the direction-of-figure judging section judges that the direction of the face of the figure in the frame image computed from the direction-of-figure computing section is not within a predetermined range with respect to the image capturing section, by a frame image of which a data amount is reduced by the data amount changing section to store the displaced frame image.

The summary of the invention does not necessarily describe all necessary features of the present invention. The present invention may also be a sub-combination of the features described above.

According to the present invention, it is possible to reduce a data amount of a frame image to reduce a data amount of a captured image.

### BRIEF DESCRIPTION OF THE DRAWINGS

The above and other objects and features and advantages of the present invention will become more apparent from the following description of the presently preferred exemplary embodiments of the invention taken in conjunction with the accompanying drawings, in which:

FIG. 1 is a conceptual diagram of a monitoring system;

FIG. 2 is a block diagram showing a functional configuration of a monitoring system;

FIG. 3 is a block diagram showing a functional configuration of a data amount reduction frame selecting section;

FIG. 4 is a block diagram showing a functional configuration of a data amount reduction frame selecting section;

FIG. 5 is a block diagram showing a functional configuration of a data amount reduction frame selecting section;

FIG. 6 is a view showing the judgment of a direction-of-figure judging section;

FIG. 7 is a flowchart of a monitoring system; and

FIG. 8 is a block diagram showing a hardware configuration of a monitoring system.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

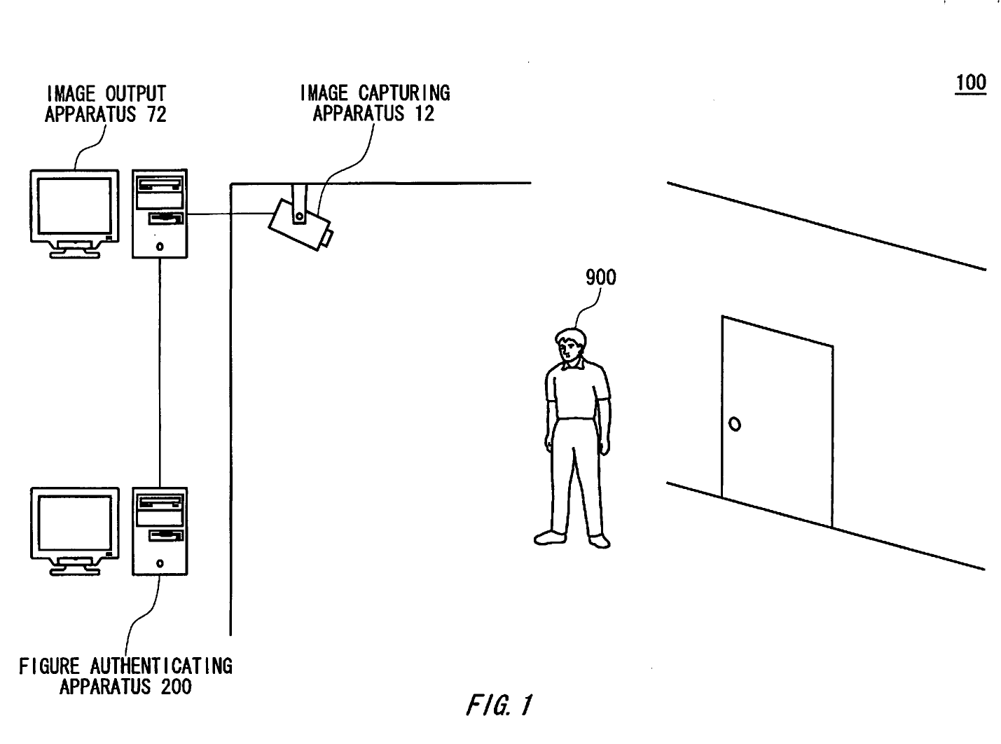

FIG. 1 is a schematic diagram showing a monitoring system 100 according to an embodiment of the present invention. The monitoring system 100 includes an image capturing apparatus 12, an image output apparatus 72, and a figure authenticating apparatus 200. An object of the monitoring system 100 according to the present embodiment is to follow a figure included in an image capturing area and authenticate the figure, and at the same time reduce a data amount of a captured image to reduce communications traffic when the captured image is sent to the image output apparatus 72 and the figure authenticating apparatus 200 after authenticating the taken figure. Furthermore, an object of the monitoring system 100 is to reduce a data amount of a captured image to save a capacity storing the captured image.

The monitoring system 100 first judges whether a subject such as a FIG. 900 is included in an image capturing area. Then, when a subject is not included in an image capturing area, the monitoring system 100 reduces a data amount of a taken frame image to store the frame image. When the monitoring system 100 judges that the FIG. 900 is included in the image capturing area, the monitoring system 100 authenticates the FIG. 900. Then, the monitoring system 100 reduces a data amount of a frame image, in which the FIG. 900 is taken, to store the frame image. Moreover, the monitoring system 100 judges whether the frame image including the FIG. 900 taken by the image capturing apparatus 12 is a frame image enough to authenticate the FIG. 900 by means of the figure authenticating apparatus 200. When a frame image enough to authenticate the FIG. 900 by means of the figure authenticating apparatus 200 is taken, the monitoring system may store the frame image to offer the frame image to the figure authenticating apparatus 200 for figure authentication. Meanwhile, the monitoring system 100 reduces a data amount of frame images including the FIG. 900, which are continuously taken next to that frame image, to store the frame images.

According to the monitoring system 100 of the present embodiment, it is possible to reduce a data amount of a frame image in which the FIG. 900 is not included when the FIG. 900 is not included in an image capturing area. Moreover, after having authenticated the FIG. 900 included in the image capturing area, it is possible to reduce a data amount of a frame image including the FIG. 900 after authentication. In this way, since a data amount of a frame image can be reduced, the monitoring system 100 can reduce communications traffic when the frame image is sent to the image output apparatus 72 and the figure authenticating apparatus 200. Furthermore, the monitoring system 100 can monitor the behavior of the FIG. 900 and authenticate the FIG. 900 while effectively reducing a capacity storing a frame image.

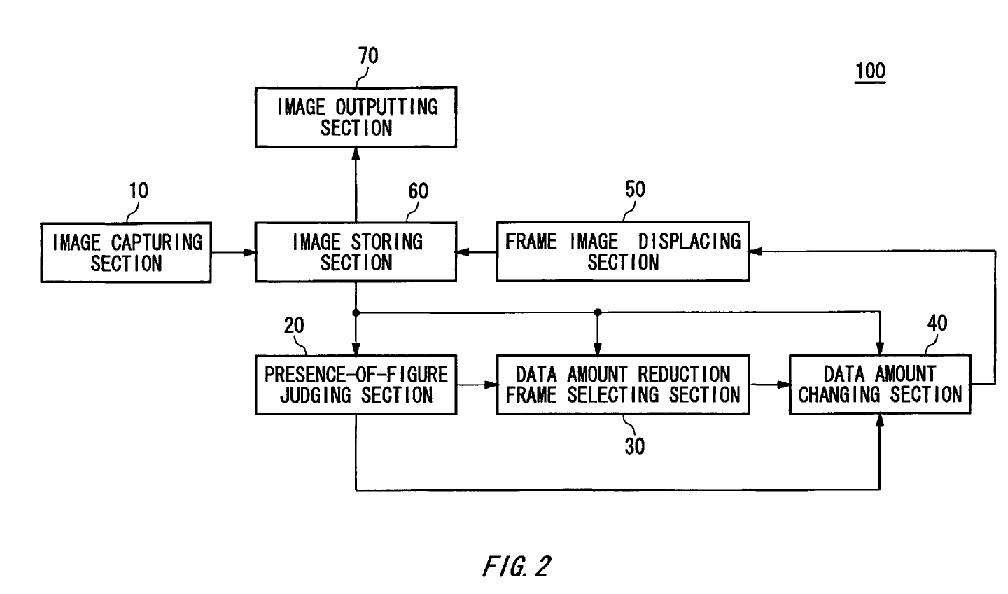

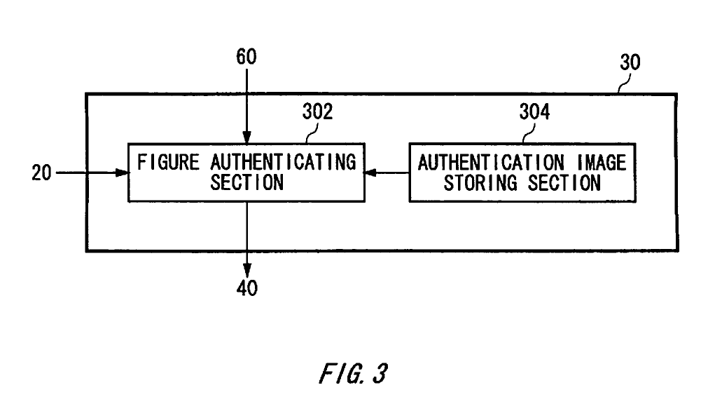

FIG. 2 is a view exemplary showing a functional configuration of the monitoring system 100 according to the present embodiment. Moreover, FIG. 3 is a view exemplary showing a functional configuration of a data amount reduction frame selecting section 30 of the monitoring system 100 according to the present embodiment. The monitoring system 100 includes an image capturing section 10, a presence-of-figure judging section 20, the data amount reduction frame selecting section 30, a data amount changing section 40, a frame image displacing section 50, an image storing section 60, and an image outputting section 70. Moreover, the data amount reduction frame selecting section 30 has a figure authenticating section 302 and an authentication image storing section 304.

The image capturing section 10 takes a moving image including a plurality of frame images. The image capturing section 10 supplies the plurality of taken frame images to the image storing section 60. The image storing section 60 stores a plurality of frame images received from the image capturing section 10 in association with a frame image identifier by which a frame image can be uniquely identified. The image storing section 60 supplies a frame image identifier and a frame image to the presence-of-figure judging section 20, the data amount reduction frame selecting section 30, and the data amount changing section 40. In addition, the image capturing apparatus 12 is an example of the image capturing section 10.

The presence-of-figure judging section 20 judges whether a figure is included in each of the plurality of frame images taken by the image capturing section 10. The presence-of-figure judging section 20 detects a subject included in the frame image by means of an image processing such as an outline extracting process and a color distribution analyzing process. Then, the presence-of-figure judging section 20 may previously store an amount of characteristic peculiar to a face of a figure. An amount of characteristic peculiar to a face of a figure may be, e.g., an outline of a face, eyes, a nose, a mouth, eyebrows, and distances between parts included in the face. The presence-of-figure judging section 20 may detect an amount of characteristic peculiar to a face of a figure by matching or the like from a subject included in a frame image, in order to judge whether the subject is a figure. The presence-of-figure judging section 20 supplies a frame image identifier for a frame image, in which the judging section has judged that a figure is included, to the data amount reduction frame selecting section 30. On the other hand, the presence-of-figure judging section 20 supplies a frame image identifier for a frame image, in which the judging section has judged that a figure is not included, to the data amount changing section 40.

The data amount reduction frame selecting section 30 selects a frame image of which a data amount is reduced based on the frame image identifier received from the presence-of-figure judging section 20 and a plurality of frames received from the image storing section 60. The data amount reduction frame selecting section 30 may have the figure authenticating section 302 and the authentication image storing section 304. The authentication image storing section 304 previously stores a face image of a figure in association with an identifier by which the face image of figure can be uniquely identified. A face image of a figure may be an image for a front side of a figure, an image for a side face of a figure, and so on. The authentication image storing section 304 supplies the face image of a figure to the figure authenticating section 302. The figure authenticating section 302 receives a frame image associated with the frame image identifier received from the presence-of-figure judging section 20 from the image storing section 60.

Then, the figure authenticating section 302 compares a face image of a figure included in the frame image received from the image storing section 60 and a face image of a figure received from the authentication image storing section 304 to judge whether the figure included in the frame image is previously registered. For example, the figure authenticating section 302 extracts a face image of a figure from the frame image received from the image storing section 60 by means of an image processing such as flesh color extraction. Then, the figure authenticating section 302 may match the face image of figure extracted from the frame image with the face image of figure received from the authentication image storing section 304 to authenticate the figure. When it has been authenticated that a figure included in each of the plurality of frame images taken by the image capturing section 10 is the figure previously registered, the figure authenticating section 302 selects an identifier for a frame image including that figure to supply the identifier to the data amount changing section 40.

When a figure included in a frame image taken by the image capturing section 10 has been authenticated by the figure authenticating section 302, the data amount changing section 40 reduces a data amount of that frame image. On the other hand, when the data amount changing section 40 receives a frame image identifier for a frame image in which the presence-of-figure judging section 20 has judged that a figure is not included, the data amount changing section 40 reduces a data amount of a frame image corresponding to the frame image identifier. The data amount changing section 40 receives a frame image corresponding to the frame image identifier received from the figure authenticating section 302 and a frame image corresponding to the frame image identifier received from the presence-of-figure judging section 20 from the image storing section 60. Then, the data amount changing section 40 performs a process for reducing a data amount of frame images received from the image storing section 60.

The data amount changing section 40 may reduce a data amount of a frame image by lowering gradation of a frame image, raising a compression rate of a frame image, and lowering resolution of a frame image. Moreover, the data amount changing section 40 may displace an image area for a figure included in a frame image taken by the image capturing section 10 by a predetermined template image. The data amount changing section 40 may displace an image area for a figure by, e.g., a template image on which a predetermined color is performed. The data amount changing section 40 supplies a frame image of which a data amount is reduced and a frame image identifier that is associated with a frame image before reducing a data amount, corresponding to the frame image of which a data amount is reduced, to the frame image displacing section 50.

The frame image displacing section 50 displaces a frame image authenticated by the figure authenticating section 302 by a frame image of which a data amount is reduced by the data amount changing section 40, among the plurality of frame images taken by the image capturing section 10. That is, the frame image displacing section 50 displaces the frame image having the reduced data amount received from the data amount changing section 40 and the frame image stored on the image storing section 60 corresponding to the frame image identifier received from the data amount changing section 40. Then, the image storing section 60 stores the frame image having the reduced data amount in association with the frame image identifier by which that frame image can be uniquely identified. Subsequently, the image storing section 60 supplies the frame image to the image outputting section 70. The image outputting section 70 outputs the frame image received from the image storing section 60 to, e.g., a monitor or the like. In addition, the image output apparatus 72 is an example of the image outputting section 70.

According to the monitoring system 100 of the present embodiment, when it is judged that a figure included in the taken frame image is a figure previously registered, the taken frame image can be displaced by the already stored frame image, a data amount of which is reduced. In this way, the monitoring system 100 can monitor the behavior of a figure included in a frame image and authenticate the figure and also reduce communications traffic when the frame image is sent to the image output apparatus 72. Furthermore, the monitoring system 100 can effectively reduce a capacity storing a frame image.

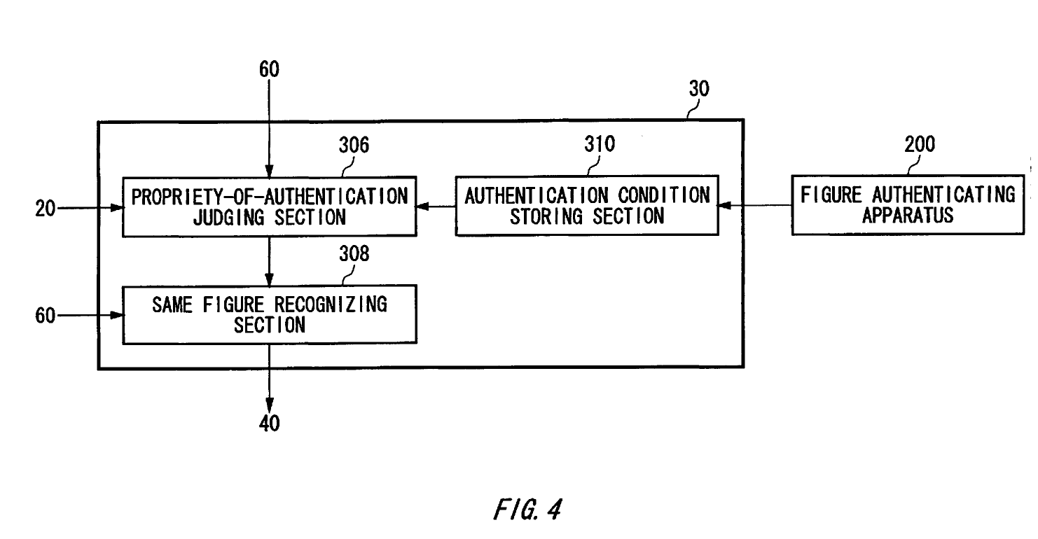

FIG. 4 is a view exemplary showing a functional configuration of a data amount reduction frame selecting section 30 included in a monitoring system 100 according to the second embodiment of the present invention. In addition, since other configurational members except the data amount reduction frame selecting section 30 are the generally same as the members shown in FIG. 2, detailed description will be omitted. In the present embodiment, the data amount reduction frame selecting section 30 has a propriety-of-authentication judging section 306, a same figure recognizing section 308, and an authentication condition storing section 310. The authentication condition storing section 310 receives and stores a condition necessary to authenticate a figure from the figure authenticating apparatus 200. A condition necessary to authenticate a figure is determined for each the figure authenticating apparatus 200 according to a characteristic of the apparatus. For example, the condition may be resolution of a face image of a figure included in a frame image, picture element number of a face area of a figure included in a frame image, a direction for the image capturing section 10 of a face of a figure included in a frame image, and gradation and a brightness of a frame image, which are necessary to authenticate a figure by means of the figure authenticating apparatus 200.

The propriety-of-authentication judging section 306 decides whether a figure included in each of frame images taken by the image capturing section 10 is a frame image enough to authenticate a figure by means of the figure authenticating apparatus 200. The propriety-of-authentication judging section 306 receives a frame image identifier for a frame image, in which it is judged that a figure is included, from the presence-of-figure judging section 20. Moreover, the propriety-of-authentication judging section 306 receives a frame image associated with the frame image identifier received from the presence-of-figure judging section 20 from the image storing section 60. Further, the propriety-of-authentication judging section 306 receives each condition necessary to authenticate a figure by means of the figure authenticating apparatus 200 from the authentication condition storing section 310. Then, the propriety-of-authentication judging section 306 judges whether the frame image received from the image storing section 60 satisfies each condition received from the authentication condition storing section 310.

Whether the frame image received from the image storing section 60 satisfies an authentication condition may be judged based on a performance required by the figure authenticating apparatus 200. For example, when resolution of a face portion of a figure included in a frame image is not less than a predetermined reference value, the propriety-of-authentication judging section 306 judges that the resolution is resolution by which the figure authenticating apparatus 200 can authenticate a figure in order to supply a frame image identifier corresponding to the frame image to the same figure recognizing section 308. Moreover, when a direction of a face of a figure included in a frame image is within a predetermined range, the propriety-of-authentication judging section 306 may judge that the direction is a direction capable of being authenticated by the figure authenticating apparatus 200 in order to supply a frame image identifier corresponding to the frame image to the same figure recognizing section 308.

The same figure recognizing section 308 receives a frame image corresponding to the frame image identifier received from the propriety-of-authentication judging section 306 from the image storing section 60. Then, the same figure recognizing section 308 selects frame images continuously taken next to a frame image, which include a figure identical with the figure included in the frame image received from the image storing section 60. The same figure recognizing section 308 may extract the figure included in the frame image by means of outline extraction and extract a face image of the figure by means of flesh color extraction. Then, the same figure recognizing section 308 matches the extracted face image with a face image of a figure included in each of the frame images continuously taken next to the frame image from which the face image is extracted. In this way, the same figure recognizing section 308 selects a frame image including a figure identical with the figure included in the frame image corresponding to the frame image identifier received from the propriety-of-authentication judging section 306. Then, the same figure recognizing section 308 supplies a frame image identifier for the selected frame image to the data amount changing section 40. The data amount changing section 40 receives a frame image corresponding to the frame image identifier received from the same figure recognizing section 308 from the image storing section 60. Then, the data amount changing section 40 reduces a data amount of the frame image.

According to the monitoring system 100 of the present embodiment, it is possible to store a frame image enough to authenticate a figure in the taken frame image by means of the figure authenticating apparatus 200 and reduce a data amount of frame images continuously taken next to the frame image. Then, it is possible to displace the frame images of which a data amount is reduced by a frame image stored on the image storing section 60. In this way, when the monitoring system 100 monitors the behavior of a subject, it is possible to effectively reduce data capacity of the captured frame image. Moreover, the figure authenticating apparatus 200 can surely store a frame image to be used for figure authentication of a subject. Furthermore, since a data amount of a captured frame image can be reduced, it is possible to effectively reduce communications traffic when the captured frame image is sent from the monitoring system 100 to the figure authenticating apparatus 200.

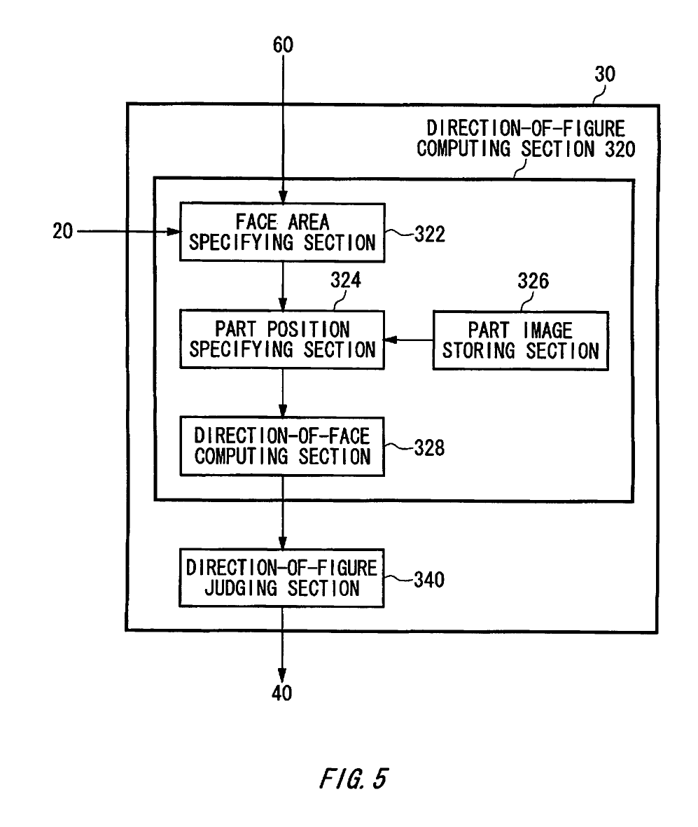

FIG. 5 is a view exemplary showing a functional configuration of a data amount reduction frame selecting section 30 included in a monitoring system 100 according to the third embodiment of the present invention. In addition, since other configurational members except the data amount reduction frame selecting section 30 are the generally same as the members shown in FIG. 2, detailed description will be omitted. In the present embodiment, the data amount reduction frame selecting section 30 has a direction-of-figure computing section 320 and a direction-of-figure judging section 340. Then, the direction-of-figure computing section 320 includes a face area specifying section 322, a part position specifying section 324, a part image storing section 326, and a direction-of-face computing section 328.

The direction-of-figure computing section 320 computes a direction for the image capturing section 10 of a face of a figure included in each of the frame images taken by the image capturing section 10. The face area specifying section 322 in the direction-of-figure computing section 320 receives a frame image identifier for a frame image including a figure from the presence-of-figure judging section 20. Moreover, the face area specifying section 322 receives a frame image corresponding to the frame image identifier received from the presence-of-figure judging section 20 from the image storing section 60. Then, the face area specifying section 322 specifies an area of a face of a figure included in the frame image. The face area specifying section 322 may specify an area of a face of a figure by means of an image processing such as pattern matching and flesh color extraction. The face area specifying section 322 supplies an image of a face area in the specified figure to the part position specifying section 324.

The part image storing section 326 stores a representative image of each part included in a face of a figure. For example, each part may be eyes, a nose, a mouth, eyebrows, ears, and an outline of a face. The part image storing section 326 supplies an image of each part to the part position specifying section 324. The part position specifying section 324 compares an image of each part included in an image of a face area received from the face area specifying section 322 and an image of each part received from the part image storing section 326. Then, the part position specifying section 324 specifies a position of a part of a face for the face area of the figure specified by the face area specifying section 322. The part position specifying section 324 supplies position information of a part of the specified face for the face to the direction-of-face computing section 328.

The direction-of-face computing section 328 computes a direction for the image capturing section 10 of a face of a figure included in the frame image taken by the image capturing section 10 based on the position of part of the face for the face area of the figure received from the part position specifying section 324. The direction-of-face computing section 328 may compute a direction for the image capturing section 10 of a face of a figure based on a bias of a part position included in a face within a figure area. For example, when an eye image extracted from a face of a figure is slantly arranged in the face of the figure, a direction for the image capturing section 10 of a figure included in a frame image may be computed based on the direction in which an eye is slantly arranged. Moreover, the direction-of-face computing section 328 may detect a direction in which the tip of nose looks from the shape of nose to compute a direction for the image capturing section 10 of the face of figure based on the direction in which the top of nose looks. The direction-of-face computing section 328 supplies the computed direction for the image capturing section 10 of the face of figure to the direction-of-figure judging section 340.

The direction-of-figure judging section 340 computes an angle formed by the direction of face of the figure received from the direction-of-figure computing section 320 and the directions from the image capturing section 10 to that figure, in order to judges whether the angle is smaller than a predetermined angle. When the computed angle is larger than the predetermined angle, the direction-of-figure judging section 340 supplies information showing that effect and a frame image identifier corresponding to a frame image including a figure, in which the computed angle is larger than the predetermined angle, to the data amount changing section 40. The data amount changing section 40 reduces a data amount of a frame image corresponding to the frame image identifier received from the direction-of-figure judging section 340.

According to the monitoring system 100 of the present embodiment, it is possible to reduce a data amount of a frame image based on the direction of face of figure included in a frame image. In this way, since a data amount of a frame image including a figure of which a face cannot be recognized can be reduced, it is possible to effectively store a frame image. Moreover, the monitoring system 100 can surely store a frame image to be used to authenticate a figure necessary for figure authentication. Furthermore, since a data amount of a captured frame image can be reduced, it is possible to reduce communications traffic when the captured frame image is sent from the monitoring system 100 to the image output apparatus 72.

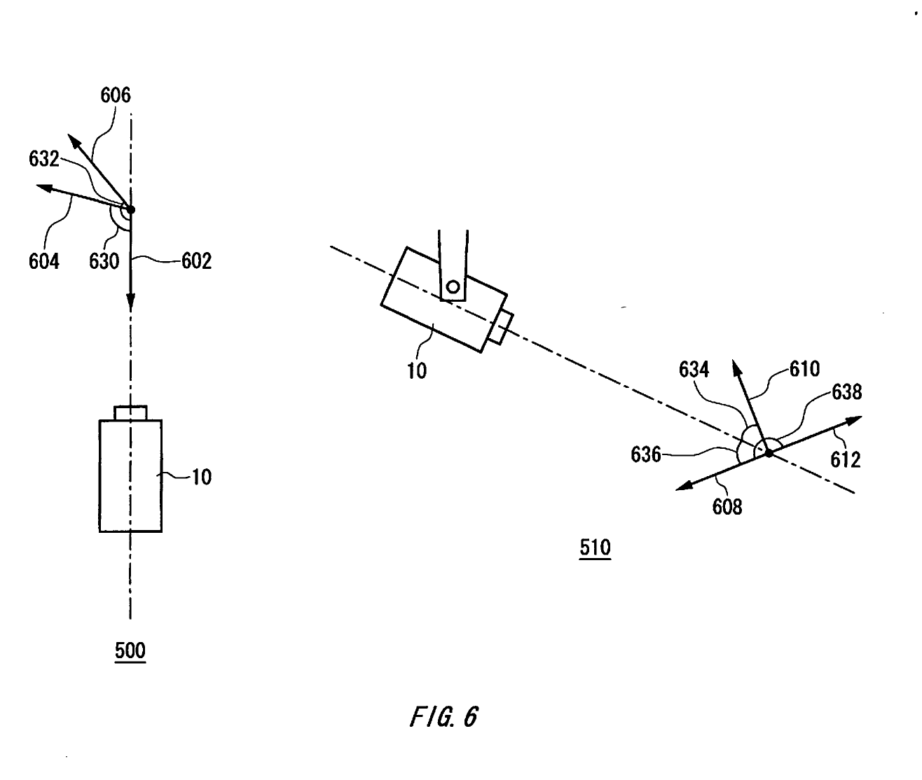

FIG. 6 is a view exemplary showing the judgment of the direction-of-figure judging section 340. The direction-of-figure judging section 340 computes an angle formed by the direction of face of figure received from the direction-of-figure computing section 320 and the direction from the image capturing section 10 to that figure, in order to judge whether the angle is smaller than a predetermined angle. First, it will be explained about an example 500 in which the image capturing section 10 and a figure are seen from above. When a direction 602 of a face of a figure computed from the direction-of-figure computing section 320 is within a predetermined angle 630, the direction-of-figure judging section 340 judge that the direction of face of figure computed from the direction-of-figure computing section 320 is within the predetermined angle for the image capturing section 10. Then, the direction-of-figure judging section 340 does not supply a frame image identifier corresponding to a frame image taken within the angle 630 to the data amount changing section 40. On the other hand, when the direction of face of figure faces a direction of an angle of 632 larger than the predetermined angle 630, the direction-of-figure judging section 340 supplies a frame image identifier corresponding to a frame image including a figure facing the direction of the angle 632 to the data amount changing section 40. Then, the data amount changing section 40 receives a frame image corresponding to the frame image identifier received from the direction-of-figure judging section 340 from the image storing section 60 in order to reduce a data amount of the frame image received from the image storing section 60. Then, the data amount changing section 40 supplies the frame image having the reduced data amount to the frame image displacing section 50.

Next, it will be explained about an example 510 in which the image capturing section 10 and a figure are seen from the side. When directions 608 and 610 of a face of a figure computed from the direction-of-figure computing section 320 is within predetermined angles 636 and 634, the direction-of-figure judging section 340 judges that the directions of face of figure computed from the direction-of-figure computing section 320 are within a predetermined range for the image capturing section 10. Then, the direction-of-figure judging section 340 does not supply a frame image identifier corresponding to a frame image taken within the angles 634 and 636 to the data amount changing section 40. On the other hand, when the direction of face of figure faces a direction of an angle 638 larger than the predetermined angles 634 and 636, the direction-of-figure judging section 340 supplies a frame image identifier corresponding to a frame image including a figure facing the direction of angle 638 to the data amount changing section 40. Then, the data amount changing section 40 receives a frame image corresponding to the frame image identifier received from the direction-of-figure judging section 340 from the image storing section 60 in order to reduce a data amount of the frame image received from the image storing section 60. Then, the data amount changing section 40 supplies the frame image having the reduced data amount to the frame image displacing section 50.

According to the monitoring system 100 of the present embodiment, when the direction of face of figure is not within a predetermined range, it is possible to reduce a data amount of a frame image including the figure. In this way, it is possible to select a frame image for which figure authentication is difficult to reduce a data amount of the frame image. Therefore, it is possible to provide the monitoring system 100 that can effectively reduce a data amount of a frame image. Moreover, since a data amount of a captured frame image can be reduced, it is possible to reduce communications traffic when the captured frame image is sent from the monitoring system 100 to the image output apparatus 72.

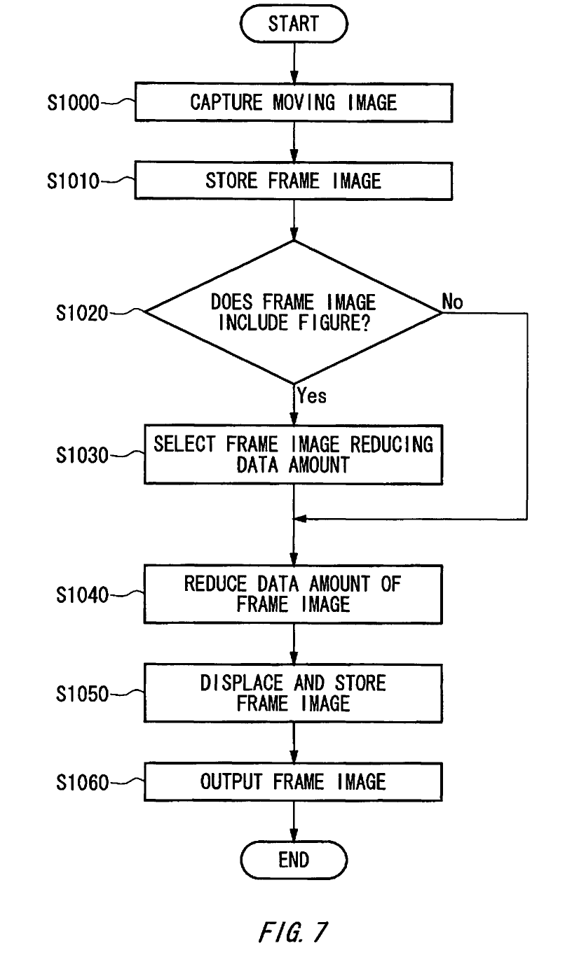

FIG. 7 is a view exemplary showing a flow of a process performed in the monitoring system 100 according to the present embodiment. First, a moving image including a plurality of frame images is taken in the image capturing section 10 (S1000). The taken frame images are supplied from the image capturing section 10 to the image storing section 60 to be stored on the image storing section 60 (S1010). Then, after the stored frame images are supplied from the image storing section 60 to the presence-of-figure judging section 20, the presence-of-figure judging section 20 decides whether a figure is included in the frame image (S1020). When the presence-of-figure judging section 20 judges that a figure is not included in the frame image (S1020: No), the frame image is supplied to the data amount changing section 40 to reduce a data amount of the frame image in which a figure is not included (S1040).

On the other hand, when the presence-of-figure judging section 20 judges that a figure is included in the frame image (S1020: Yes), a frame image identifier for the frame image is supplied from the presence-of-figure judging section 20 to the data amount reduction frame selecting section 30. The data amount reduction frame selecting section 30 receives a frame image corresponding to the frame image identifier received from the presence-of-figure judging section 20 from the image storing section 60. Then, the data amount reduction frame selecting section 30 selects a frame image having the reduced data amount based on a method described with reference to FIGS. 3, 4, and 5 (S1030).

For example, when the data amount reduction frame selecting section 30 includes the figure authenticating section 302 and the authentication image storing section 304, the figure authenticating section 302 authenticates whether a figure included in each of the plurality of frame images taken by the image capturing section 10 is a figure previously registered. Then, when a figure included in each of the frame images is a figure previously registered, the data amount reduction frame selecting section 30 selects a frame image including the figure. Moreover, when the data amount reduction frame selecting section 30 includes the propriety-of-authentication judging section 306, the same figure recognizing section 308, and the authentication condition storing section 310, the propriety-of-authentication judging section 306 judges whether a figure included in each of the taken frame images is a frame image enough to authenticate a figure by means of the figure authenticating apparatus 200. Then, when the propriety-of-authentication judging section 306 judges that the figure is a frame image enough to authenticate a figure by means of the figure authenticating apparatus 200, frame images continuously taken next to the frame image including the figure, which include a figure identical with the figure included in the frame image, are selected.

Furthermore, when the data amount reduction frame selecting section 30 includes the direction-of-figure computing section 320 and the direction-of-figure judging section 340, the direction-of-figure computing section 320 computes a direction for the image capturing section 10 of a figure included in each of the frame images taken by the image capturing section 10. Then, the direction-of-figure judging section 340 judges whether an angle formed by a direction for the image capturing section 10 of a figure computed from the direction-of-figure computing section 320 and a directions from the image capturing section 10 to the figure is within a predetermined range. Then, the direction-of-figure judging section 340 selects a frame image including a figure judged that an angle formed by the direction of face of figure computed from the direction-of-figure computing section 320 and the direction from the image capturing section 10 to the figure is larger than a predetermined angle. The data amount reduction frame selecting section 30 supplies a frame image identifier corresponding to the selected frame image to the data amount changing section 40.

The data amount changing section 40 reduces a data amount of the frame image selected by the data amount reduction frame selecting section 30 (S1040). Then, the data amount changing section 40 supplies the frame image having the reduced data amount to the frame image displacing section 50. The frame image displacing section 50 displaces a frame image, before reducing a data amount, corresponding to the frame image having the reduced data amount by the frame image received from the data amount changing section 40, in order to store the displaced frame image on the image storing section 60 (S1050). Then, the image storing section 60 supplies the stored frame image to the image outputting section 70, and the image outputting section 70 outputs the frame image received from the image storing section 60 to a monitor or the like.

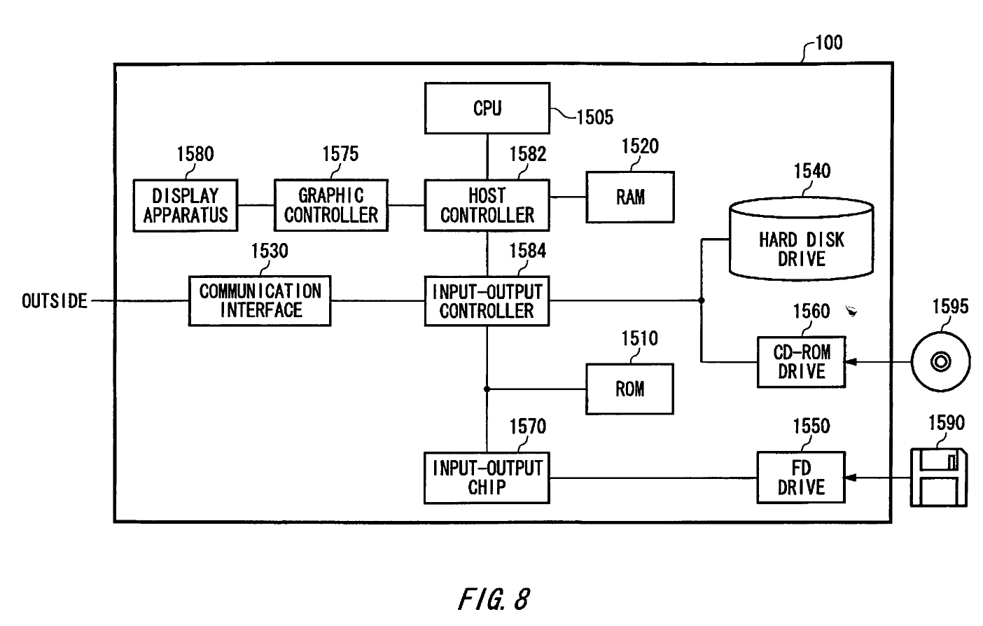

FIG. 8 is a view exemplary showing a hardware configuration of the monitoring system 100 according to the present embodiment. The monitoring system 100 according to the present embodiment includes a CPU peripheral section having a CPU 1505, a RAM 1520, a graphic controller 1575, and a display apparatus 1580 that are connected to one another by a host controller 1582, an input-output section having a communication interface 1530, a hard disk drive 1540, and a CD-ROM drive 1560 that are connected to the host controller 1582 by an input-output controller 1584, and a legacy input-output section having a ROM 1510, a flexible disk drive 1550, and an input-output chip 1570 that are connected to the input-output controller 1584.

The host controller 1582 connects the RAM 1520 to the CPU 1505 and the graphic controller 1575 for accessing the RAM 1520 at high transfer rate. The CPU 1505 operates based on a program stored on the ROM 1510 and the RAM 1520 to control each section. The graphic controller 1575 acquires image data generated by the CPU 1505 on a frame buffer provided in the RAM 1520, and displays the data on the display apparatus 1580. Alternatively, the graphic controller 1575 may include therein the frame buffer storing the image data generated from the CPU 1505.

The input-output controller 1584 connects the host controller 1582 to the communication interface 1530, the hard disk drive 1540, and the CD-ROM drive 1560 that are a comparatively fast input-output apparatus. The communication interface 1530 communicates with the other apparatuses. The hard disk drive 1540 stores a program and data to be used by the CPU 1505 in the monitoring system 100. The CD-ROM drive 1560 reads a program or data from a CD-ROM 1595, and provides the program or data to the hard disk drive 1540 via the RAM 1520.

Moreover, the ROM 1510, the flexible disk drive 1550, and the input-output chip 1570 that are a comparatively low-speed input-output apparatus are connected to the input-output controller 1584. The ROM 1510 stores a boot program to be executed during starting the monitoring system 100, a program dependent on hardware of the monitoring system 100, or the like. The flexible disk drive 1550 reads a program or data from a flexible disk 1590, and provides the program or data to the hard disk drive 1540 via the RAM 1520. The input-output chip 1570 connects the flexible disk drive 1550 to various kinds of input-output apparatuses via a parallel port, a serial port, a keyboard port, a mouse port, or the like.

A monitoring program provided to the hard disk drive 1540 via the RAM 1520 is stored on a recording medium such as the flexible disk 1590, the CD-ROM 1595, or an IC card in order to be provided by a user. The monitoring program is read from the recording medium, is installed in the hard disk drive 1540 in the monitoring system 100 via the RAM 1520, and is executed by the CPU 1505. The monitoring program to be installed and executed in the monitoring system 100 works on the CPU 1505, and makes the monitoring system 100 function as the image capturing section 10, the presence-of-figure judging section 20, the data amount reduction frame selecting section 30, the data amount changing section 40, the frame image displacing section 50, the image storing section 60, the image outputting section 70, the figure authenticating section 302, and the authentication image storing section 304, described in FIGS. 1 to 7.

Although the present invention has been described by way of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

What is claimed is:

1. A monitoring system comprising:
an image capturing section that takes a moving image including a plurality of frame images;
a figure authenticating section that authenticates whether a figure included in each of a plurality of frame images taken by said image capturing section is a figure previously registered;
a data amount changing section that reduces, when a figure included in a frame image taken by said image capturing section has been authenticated by said figure authenticating section, a data amount of that frame image; and
an image storing section that displaces, among the plurality of frame images taken by said image capturing section, a frame image in which a figure has been authenticated by said figure authenticating section by a frame image of which a data amount has been reduced by said data amount changing section to store the displaced frame image.

2. The monitoring system as claimed in claim 1, wherein
said monitoring system further comprises a presence-of-figure judging section that judges whether a figure is included in each of the plurality of frame images taken by said image capturing section,
said data amount changing section reduces a data amount of a frame image in which said presence-of-figure judging section has judged that a figure is not included, and
said image storing section displaces, among the plurality of frame images taken by said image capturing section, a frame image in which said presence-of-figure judging section has judged that a figure is not included by the frame image taken by said image capturing section to store the frame image of which a data amount has been reduced by said data amount changing section.

3. The monitoring system as claimed in claim 1, wherein said data amount changing section displaces an image area of a figure included in the frame image taken by said image capturing section by a predetermined template image in order to reduce a data amount of the frame image taken by said image capturing section.

4. A monitoring method comprising:
a figure authenticating step of authenticating whether a figure included in each of a plurality of frame images taken by an image capturing section for taking a moving image is a figure previously registered;
a data amount changing step of reducing, when a figure included in a frame image taken by the image capturing section has been authenticated in said figure authenticating step, a data amount of that frame image; and
an image storing step of displacing, among the plurality of frame images taken by the image capturing section, a frame image in which a figure has been authenticated in said figure authenticating step by a frame image of which a data amount has been reduced in said data amount changing step to store the displaced frame image.

5. A monitoring program for a monitoring system, the monitoring program making the monitoring system function as:
an image capturing section that takes a moving image including a plurality of frame images;
a figure authenticating section that authenticates whether a figure included in each of a plurality of frame images taken by said image capturing section is a figure previously registered;
a data amount changing section that reduces, when a figure included in a frame image taken by said image capturing section has been authenticated by said figure authenticating section, a data amount of that frame image; and
an image storing section that displaces, among the plurality of frame images taken by said image capturing section, a frame image in which a figure has been authenticated by said figure authenticating section by a frame image of which a data amount has been reduced by said data amount changing section to store the displaced frame image.

6. A monitoring system comprising:
an image capturing section that takes a moving image including a plurality of frame images;
a propriety-of-authentication judging section that judges whether a figure included in each of the frame images taken by said image capturing section is a frame image enough to be authenticated by a figure authenticating apparatus;
a data amount changing section that reduces, when said propriety-of-authentication judging section judges that a figure included in a frame image taken by said image capturing section is an image enough to be authenticated by the figure authenticating apparatus, a data amount of frame images that are continuously taken next to that frame image and include a figure identical with the figure included in that frame image; and
an image storing section that displaces, among the plurality of frame images taken by said image capturing section, frame images that are continuously taken next to a frame image, in which said propriety-of-authentication judging section judges that the frame image is an image enough to be authenticated by the figure authenticating apparatus, and include a figure identical with the figure included in that frame image by a frame image of which a data amount has been reduced by said data amount changing section to store the displaced frame images.

7. The monitoring system as claimed in claim 6, wherein said propriety-of-authentication judging section judges whether resolution of a face portion of the figure included in the frame image taken by said image capturing section is resolution by which said figure authenticating apparatus can authenticate a figure.

8. The monitoring system as claimed in claim 6, wherein said propriety-of-authentication judging section judges whether the direction of a face of the figure included in the frame image taken by said image capturing section is the direction of a face by which said figure authenticating apparatus can authenticate a figure.

9. A monitoring method comprising:
a propriety-of-authentication judging step of judging whether a figure included in each of frame images taken by an image capturing section for taking a moving image is a frame image enough to be authenticated by a figure authenticating apparatus;
a data amount changing step of reducing, when said propriety-of-authentication judging step judges that a figure included in a frame image taken by said image capturing section is an image enough to be authenticated by the figure authenticating apparatus, a data amount of frame images that are continuously taken next to that frame image and include a figure identical with the figure included in that frame image; and
an image storing step of displacing, among the plurality of frame images taken by said image capturing section, frame images that are continuously taken next to a frame image, in which said propriety-of-authentication judging step judges that the frame image is an image enough to be authenticated by the figure authenticating apparatus, and include a figure identical with the figure included in that frame image by a frame image of which a data amount has been reduced in said data amount changing step to store the displaced frame images.

10. A monitoring program for a monitoring system, the monitoring program making the monitoring system function as:
an image capturing section that takes a moving image including a plurality of frame images;
a propriety-of-authentication judging section that judges a figure included in each of the frame images taken by said image capturing section is a frame image enough to be authenticated by a figure authenticating apparatus;
a data amount changing section that reduces, when said propriety-of-authentication judging section judges that a figure included in a frame image taken by said image capturing section is an image enough to be authenticated by the figure authenticating apparatus, a data amount of frame images that are continuously taken next to that frame image and include a figure identical with the figure included in that frame image; and
an image storing section that displaces, among the plurality of frame images taken by said image capturing section, frame images that are continuously taken next to a frame image, in which said propriety-of-authentication judging section judges that the frame image is an image enough to be authenticated by the figure authenticating apparatus, and include a figure identical with the figure included in that frame image by a frame image of which a data amount has been reduced by said data amount changing section to store the displaced frame images.

11. A monitoring system comprising:
an image capturing section that takes a moving image including a plurality of frame images;
a direction-of-figure computing section that computes a direction for said image capturing section of a face of a figure included in each of frame images taken by said image capturing section;
a direction-of-figure judging section that judges whether an angle formed by the direction of the face of the figure computed from said direction-of-figure computing section and a direction from said image capturing section to that figure is smaller than a predetermined angle;
a data amount changing section that reduces a data amount of that frame image when said direction-of-figure judging section judges that an angle formed by the direction of the face of the figure computed from said direction-of-figure computing section and the direction from said image capturing section to that figure is smaller than the predetermined angle; and
an image storing section that displaces, among the plurality of frame images taken by said image capturing section, a frame image, in which said direction-of-figure judging section judges that the direction of the face of the figure in the frame image computed from said direction-of-figure computing section is not within a predetermined range with respect to said image capturing section, by a frame image of which a data amount is reduced by said data amount changing section to store the displaced frame image.

12. The monitoring system as claimed in claim 11, wherein
said direction-of-figure computing section comprises:
a face area specifying section that specifies an area of a face of a figure included in the frame image taken by said image capturing section;
a part position specifying section that specifies a position of a part of the face for the area of the face of the figure specified by said face area specifying section; and
a direction-of-face computing section that computes a direction for said image capturing section of the face of the figure included in the frame image taken by said image capturing section based on the position of the part of the face for the area of the face of the figure specified by said part position specifying section.

13. A monitoring method comprising:
a direction-of-figure computing step of computing a direction for an image capturing section of a face of a figure included in each of frame images taken by the image capturing section for taking a moving image;
a direction-of-figure judging step of judging whether an angle formed by the direction of the face of the figure computed in said direction-of-figure computing step and a direction from the image capturing section to that figure is smaller than a predetermined angle;
a data amount changing step of reducing a data amount of that frame image when said direction-of-figure judging step judges that an angle formed by the direction of the face of the figure computed in said direction-of-figure computing step and the direction from the image capturing section to that figure is smaller than the predetermined angle; and
an image storing step of displacing, among the plurality of frame images taken by the image capturing section, a frame image, in which said direction-of-figure judging step judges that the direction of the face of the figure in the frame image computed in said direction-of-figure computing step is not within a predetermined range with respect to the image capturing section, by a frame image of which a data amount is reduced in said data amount changing step to store the displaced frame image.

14. A monitoring program for a monitoring system, the monitoring program making the monitoring system function as:
an image capturing section that takes a moving image including a plurality of frame images;
a direction-of-figure computing section that computes a direction for said image capturing section of a face of a figure included in each of frame images taken by said image capturing section;
a direction-of-figure judging section that judges whether an angle formed by the direction of the face of the figure computed from said direction-of-figure computing section and a direction from said image capturing section to that figure is smaller than a predetermined angle;
a data amount changing section that reduces a data amount of that frame image when said direction-of-figure judging section judges that an angle formed by the direction of the face of the figure computed from said direction-of-figure computing section and the direction from said image capturing section to that figure is smaller than the predetermined angle; and
an image storing section that displaces, among the plurality of frame images taken by said image capturing section, a frame image, in which said direction-of-figure judging section judges that the direction of the face of the figure in the frame image computed from said direction-of-figure computing section is not within a predetermined range with respect to said image capturing section, by a frame image of which a data amount is reduced by said data amount changing section to store the displaced frame image.
